(19) United States
(12) Patent Application Publication
(10) Pub. No.: US 2014/0154609 A1
(43) Pub. Date: Jun. 5, 2014

(54) ELECTRODE CATALYST FOR FUEL CELL, METHOD OF PREPARING THE SAME, ELECTRODE FOR FUEL CELL INCLUDING THE ELECTRODE CATALYST, AND FUEL CELL INCLUDING THE ELECTRODE

(71) Applicant: Samsung Electronics Co., Ltd., Suwon-si (KR)

(72) Inventors: Dae-jong YOO, Seoul (KR); Chan-ho PAK, Seoul (KR); Seon-ah JIN, Pocheon-si (KR); Kang-hee LEE, Suwon-si (KR)

(73) Assignee: Samsung Electronics Co., Ltd., Suwon-si (KR)

(21) Appl. No.: 14/034,675

(22) Filed: Sep. 24, 2013

(30) Foreign Application Priority Data
Nov. 30, 2012 (KR) 10-2012-0138509

(51) Int. Cl. H01M 4/92

(52) U.S. Cl. CPC H01M 4/921
USPC 429/482; 429/525

(57) ABSTRACT

An electrode catalyst for a fuel cell, wherein the electrode catalyst includes an active particle including: a core including an alloy represented by Formula 1

PdCuₐM_{b} Formula 1

wherein M is a transition metal, 0.05≦a≦0.32, and 0<b≦0.2; and a shell including a Pd alloy on the core.

### CROSS-REFERENCE TO RELATED APPLICATIONS

This application claims priority to and the benefit of Korean Patent Application No. 10-2012-0138509, filed on Nov. 30, 2012, and all the benefits accruing therefrom under 35 U.S.C. §119, the content of which is incorporated herein in its entirety by reference.

### BACKGROUND

1. Field

The present disclosure relates to an electrode catalyst for a fuel cell, a method of preparing the same, an electrode for a fuel cell including the electrode catalyst, and a fuel cell including the electrode.

2. Description of the Related Art

According to a type of an electrolyte and fuel used, fuel cells can be classified as a polymer electrolyte membrane fuel cell (“PEMFC”), a direct methanol fuel cell (“DMFC”), a phosphoric acid fuel cell (“PAFC”), a molten carbonate fuel cell (“MCFC”), or a solid oxide fuel cell (“SOFC”).

PEMFCs and DMFCs include a membrane-electrode assembly (“MEA”) that includes a cathode, an anode, and a polymer electrolyte membrane interposed between the cathode and the anode. The anode of the fuel cells includes a catalyst layer for catalyzing the oxidation of a fuel, and the cathode includes a catalyst layer for catalyzing the reduction of an oxidant.

In general, a catalyst having platinum (Pt) as an active component is used as an element of the cathode and the anode. However, the platinum used in a Pt-based catalyst is an expensive noble metal. To reduce a cost of the electrode, use of less platinum in the electrode catalyst would be desirable to reduce cost and allow for mass production of commercially operable fuel cells. Therefore, the development of an electrode catalyst, which provides suitable cell performance as well as a decrease in the amount of platinum used, is desired.

### SUMMARY

Provided is an electrode catalyst for a fuel cell with excellent catalyst activity, a method of preparing the same, an electrode for a fuel cell including the electrode catalyst, and a fuel cell including the electrode.

Additional aspects will be set forth in part in the description which follows and, in part, will be apparent from the description.

According to an aspect, an electrode catalyst for a fuel cell includes an active particle including a core including an alloy represented by Formula 1:

PdCuₐM_{b} Formula 1

wherein M is a transition metal, 0.05≦a≦0.32, and 0<b≦0.2; and a shell including a Pd alloy on the core.

According to another aspect, an electrode for a fuel cell is provided, wherein the electrode includes an electrode catalyst including an active particle including: a core including an alloy represented by Formula 1

PdCuₐM_{b} Formula 1

wherein M is a transition metal, 0.05≦a≦0.32, and 0<b≦0.2; and a shell including a Pd alloy on the core.

According to another aspect, a fuel cell is provided, wherein the fuel cell includes a cathode; an anode disposed facing the cathode; and an electrolyte membrane interposed between the cathode and the anode, wherein at least one of the cathode and the anode includes the electrode catalyst.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of an embodiment of a method of forming an electrode catalyst;

FIG. 2 is an exploded perspective view of an embodiment of a fuel cell;

FIG. 3 is a schematic cross-sectional view of an embodiment of a membrane electrode assembly (“MEA”) of the fuel cell of FIG. 2;

FIGS. 4A to 4D are micrographs illustrating results of high-resolution transmission electron microscopy (“HR-TEM”) analysis of electrode catalysts prepared in Examples 1-2 and Comparative Examples 1-2, respectively;

FIGS. 4E to 4H are enlarged views of the micrographs of FIGS. 4A to 4D, respectively;

FIG. 5 is a graph of relative intensity (arbitrary units, A.U.) versus diffraction angle (degrees two theta, 2θ) illustrating results of X-ray diffraction (XRD) analysis of the electrode catalysts prepared in Examples 1-2 and Comparative Examples 1-2;

FIG. 6 is a graph of current density (milliamperes per square centimeter, mA/cm²) versus potential (volts versus a normal hydrogen electrode, V vs. NHE) illustrating the results of cyclic voltammetry analysis of the electrode catalysts prepared in Examples 1-2 and Comparative Examples 1-2;

FIG. 7 is a graph of current density (milliampheres per square centimeter, mA/cm²) versus potential (volts versus a normal hydrogen electrode, V vs. NHE) illustrating oxygen reduction reaction (“ORR”) characteristics of an electrode including each of the electrode catalysts prepared in Examples 1-2 and Comparative Examples 1-2; and

FIG. 8 is a graph of cell voltage (volts, V) versus current density (milliamperes per square centimeter, mA/cm²) for unit cells using the electrode catalysts prepared in Examples 1-2 and Comparative Examples 1-2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. “Or” means “and/or.” Expressions such as “at least one of” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Transition metal” as defined herein refers to an element of Groups 3 to 12 of the Periodic Table of the Elements.

Hereinafter, according to an embodiment, an electrolyte catalyst for a fuel cell with an excellent catalyst activity, a method of preparing the same, an electrode for a fuel cell including the electrode catalyst, and a fuel cell including the electrode will be further disclosed.

The electrode catalyst includes non-platinum (Pt) based active particles having suitable oxygen-reduction activity.

The electrode catalyst comprises an active particle including a core that comprises an alloy represented by Formula 1 including palladium (Pd), copper (Cu), and a transition metal (M); and a shell including a Pd-based alloy on the core.

PdCuₐM_{b} Formula 1

In Formula 1, M is a transition metal, 0.05≦a≦0.32, and 0<b≦0.2.

In Formula 1, a and b respectively denote a content (e.g., moles) of Cu and the transition metal (M), respectively, based on 1 mole of Pd.

In an embodiment, 0.1≦a≦0.30, specifically 0.15≦a≦0.25. In Formula 1, in an embodiment, 0.03≦b≦0.2, specifically 0.05≦b≦0.15.

When a and b of Formula 1 are within the ranges above, oxygen reduction activity of the electrode catalyst may be excellent. While not wanting to be bound by theory, it is understood that the desirable ORR activity is provided because when Pd and the Cu-M alloy bind within the ranges above, the binding energy with respect to oxygen is lowered, and a size of the active particles may be reduced. In this regard, when the size of the active particles is reduced, electrochemical activity of the electrode catalyst is increased.

The Pd-based alloy may be a palladium-iridium (Pd—Ir) alloy represented by the following Formula 2.

Pd_{b}Ir_{d} Formula 2

In Formula 2, 0.15≦c≦0.38, and 0.075≦d≦0.22. In an embodiment, 0.20≦c≦0.35, and 0.08≦d≦0.20, specifically 0.25≦c≦0.30, and 0.1≦d≦0.18.

In Formula 2, c and d respectively denote a content (e.g., moles) of Pd and Ir, respectively, based on 1 mole of Pd of the alloy of the core, wherein the alloy of the core is represented by Formula 1, which includes Pd, Cu, and the transition metal (M).

When c and d of Formula 2 are within the ranges above, oxygen-reduction activity of the electrode catalyst may be improved.

In Formula 1, the transition metal (M) may be at least one selected from vanadium (V), chromium (Cr), iron (Fe), manganese (Mn), cobalt (Co), nickel (Ni), and zinc (Zn).

The alloy represented by Formula 1 including Pd, Cu, and the transition metal (M) may be, for example, at least one selected from PdNi_{0.16}Cu_{0.09} and PdNi_{0.12}Cu_{0.14}, specifically PdNi_{0.16}Cu_{0.09} or PdNi_{0.12}Cu_{0.14}, and the Pd—Ir alloy of the shell and represented by Formula 2 may be, for example, Pd_{0.19}Ir_{0.19}.

The electrode catalyst may further include a carbonaceous support. Here, the active particles may be disposed on, e.g., supported in, the carbonaceous support. In an embodiment the active particles are supported on the carbonaceous support without aggregation. The active particles may be disposed on the carbonaceous support by dispersing the active particles on the support.

The carbonaceous support may comprise at least one selected from ketjen black, carbon black, graphite, carbon nanotubes, carbon fiber, mesoporous carbon, mesocarbon microbeads, oil furnace black, extra-conductive black, acetylene black, lamp black, and the like, but not limited thereto, and the carbonaceous support may be used singularly or in a combination.

The carbonaceous support may be amorphous or graphitic, and may be heat treated to increase its corrosion resistance. The carbonaceous support may have a Brunauer, Emmett, and Teller (“BET”) surface area of about 50 m²/g to about 2000 m²/g, specifically about 500 m²/g to about 1500 m²/g. The carbonaceous support may have an average particle size of about 50 nanometers (nm) to about 500 nm, specifically 100 nm to about 400 nm.

The content of the active particles may be about 20 parts to about 80 parts by weight, for example, about 30 parts to about 60 parts by weight, based on 100 parts by weight of a total weight of the electrode catalyst (i.e., including the active particles and the carbonaceous support if present). When the content of the active particles in the electrode catalyst is within the range above, a specific surface area of the electrode catalyst may be improved, and a suitably high content of the active particles may be supported, and thus an activity of the electrode catalyst may be improved.

The active particles of the electrode catalyst may have any suitable shape, and may be rectilinear or curvilinear, and may be at least one selected from spherical, rectangular, square, platelets, and rod-shaped.

The carbonaceous support may include an ordered mesoporous carbon having mesopores. An average diameter of the mesopores may be from about 6 nanometers (nm) to about 10 nm. The ordered mesoporous carbon having the mesopores may be manufactured using a mesoporous silica template (e.g., MSU-H.). Since the ordered mesoporous carbon has a large specific surface area, e.g., about 500 m²/g to about 1500 m²/g, when the mesoporous carbon is used as the carbonaceous support, a relatively greater content of the active particles may be supported with respect to a weight of the carbonaceous support.

An average particle diameter of a plurality of the active particles of the electrode catalyst may be from about 1 nm to about 20 nm, for example, from about 3 nm to about 10 nm. When the average particle diameter is within the range above, excellent oxygen reduction activity and an electrochemical specific surface area of the electrode catalyst may be maintained.

Here, when the average particle diameter of the active particles of the electrode catalyst is within the range above, oxygen reduction activity of the electrode catalyst including the active particles may be excellent.

A weight ratio of the core to the shell may be from about 1:1 to about 1.5:1, specifically about 1.05:1 to about 1.45:1, more specifically about 1.1:1 to about 1.4:1. The weight ratio may be obtained by inductively coupled plasma (“ICP”) analysis.

A method of obtaining the weight ratio of the core to the shell is further described below.

When a Pd—Ni—Cu supported catalyst is used to form the core of the electrode catalyst and when a Pd—Ir alloy is used to form the shell, a weight ratio of the constituents of a core-shell catalyst (e.g., Pt, Ir, Ni, and Cu) may be obtained for each by ICP. Since an atomic ratio of Ir in the shell to Pd is about 1:1, a content of Pd in the shell may be calculated from a content of Ir, and thus a content of the Pd—Ir alloy of the shell may be calculated. Also, a content other than the content of the Pd—Ir alloy of the shell from the total weight of the electrode catalyst may be determined to be a content of the Pd—Ni—Cu in the core. In this regard, a total weight percent (weight %) of the Pd—Ni—Cu alloy of the core and a total weight % of the Pd—Ir alloy of the shell may be calculated. In addition, a weight ratio of the core to the shell may be obtained from the weight % of the Pd—Ni—Cu alloy and the weight % of the Pd—Ir alloy.

The electrode catalyst desirably has a very large specific surface area for contacting a gas and/or a liquid of an electrochemical reaction. The electrode catalyst may be, for example, useful as an electrode catalyst for a fuel cell.

An electrochemical specific surface area of the electrode catalyst may be about 70 square meters per gram (m²/g) or greater, for example, from about 70 m²/g to about 100 m²/g, but is not limited thereto.

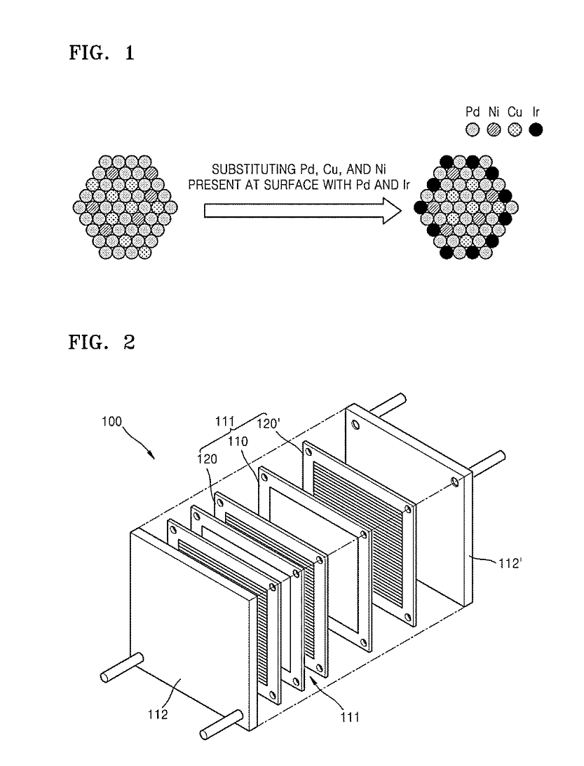

FIG. 1 is a schematic view of a method of forming an electrode catalyst according to an embodiment.

As an example of the alloy of Formula 1 including Pd, Cu, and a transition metal to form a core, a Pd—Ni—Cu alloy is illustrated, and a Pd—Ir alloy of Formula 2 for forming a shell is illustrated.

In this regard, Pd is used to form a Pd—Cu—Ni alloy together with Cu and Ni, and a core is formed of the Pd—Cu—Ni alloy. Some of the Pd—Cu—Ni alloy present on a surface of the core is substituted to provide the Pd—Ir alloy, and thus a catalyst having the core comprising the Pd—Cu—Ni alloy and the shell comprising the Pd—Ir alloy may be formed. While not wanting to be bound by theory, it is understood that when the electrode catalyst has such a structure, an oxygen binding energy of the catalyst itself may be changed so as to form a structure similar to that of platinum. It is understood that this is because a change in an electron state (e.g., from a ligand effect) of the Pd—Ni—Cu alloy of the core and an imbalance (e.g., a strain effect) between the Pd and Ir of the shell may increase. Thus when Ir binds to Pd, and a durability of Pd is increased, stability of the electrode catalyst may be increased.

Moreover, as a degree of alloying of the core and the shell increase, an average particle diameter of the electrode catalyst may be reduced. In this regard, when the average particle diameter of the electrode catalyst is reduced, electrochemical activity of the electrode catalyst may be increased.

Hereinafter, a method of preparing the electrode catalyst for a fuel cell will be further disclosed. In an embodiment, a method of preparing an electrode catalyst for a fuel cell comprises providing a pre-catalyst including an alloy including Pd, Cu, and a transition metal (M); contacting the pre-catalyst, a Pd alloy precursor, and a solvent to form a mixture; and heat-treating the mixture to prepare the electrode catalyst for a fuel cell.

An electrode catalyst composition may be obtained by preparing a pre-catalyst comprising an alloy comprising Pd, Cu, and a transition metal, and contacting, e.g., mixing, the pre-catalyst including Pd, Cu, and the transition metal M, a Pd-based alloy precursor, and a solvent to form a mixture.

A Pd—Ir alloy precursor may be used as the Pd-based alloy precursor.

Next, the mixture may be heat-treated to prepare the electrode catalyst. While not wanting to be bound by theory, it is understood that the heat-treating results in a galvanic replacement reaction. After the galvanic replacement reaction is completed, a resulting product may be optionally filtered, washed, and dried.

A temperature for the heat-treating, e.g., the galvanic replacement reaction, may be from about room temperature (e.g., about 20° C.) to about 200° C., specifically about 30° C. to about 150° C. When the temperature for the heat-treating is within the range above, a rate of the galvanic replacement reaction is excellent.

The Pd-based alloy precursor may include, for example, a Pd precursor and an Ir precursor.

The Pd precursor may be a palladium salt, and may be at least one compound selected from palladium nitrate, palladium chloride, palladium sulfate, palladium acetate, palladium acetylacetonate, palladium cyanate, palladium isopropyl oxide, palladium butoxide, and K₂PdCl₄, but is not limited thereto.

The Ir precursor may be an iridium salt, and may be at least one compound selected from iridium nitrate, iridium chloride, iridium sulfate, iridium acetate, iridium acetylacetonate, iridium cyanate, iridium isopropyl oxide, iridium butoxide, and H₂IrCl₆.6H₂O, but is not limited thereto.

The solvent for the mixture to prepare the electrode catalyst composition may be at least one selected from water; a glycol-based solvent, such as ethylene glycol, 1,2-propylene glycol, 1,3-butanediol, 1,4-butanediol, neopentyl glycol, diethylene glycol, 3-methyl-1,5-pentanediol, 1,6-hexanediol, or trimethylol propane; an alcohol-based solvent, such as methanol, ethanol, isopropylalcohol (“IPA”), or butanol; or a combination thereof, but is not limited thereto, and any suitable solvent that may suspend or dissolve the precursors may be used.

A content of the solvent may be from about 100 parts to about 2000 parts by weight, specifically about 200 parts to about 1500 parts by weight, based on 100 parts by weight of the Pd precursor.

A carbonaceous support may be further added to the electrode catalyst composition.

According to an embodiment, the pre-catalyst may be prepared in the same manner and will further disclosed below.

A metal precursor mixture including a Pd precursor, a Cu precursor, a transition metal (M) precursor and a solvent is prepared and placed in an autoclave reactor.

Then, the metal precursor mixture in the autoclave reactor may be reduced at a high pressure and high temperature, and a product of the reduction reaction may be filtered, washed, and dried to obtain the pre-catalyst.

A reaction temperature of the autoclave reactor may be from about 200° C. to about 300° C. When the reaction temperature is within the range above, uniform alloy particles may be formed during the reduction of the Pd precursor, Cu precursor, and transition metal (M) precursor, and when the carbonaceous support is added to the metal precursor mixture, a dispersibility of the pre-catalyst particles in the carbonaceous support is excellent.

The autoclave reactor is a pressurizable and heatable reactor, in which a temperature of the reaction mixture may be increased to a boiling point of the solvent or higher.

The solvent for the metal precursor mixture may be at least one selected from a glycol-based solvent, such as ethylene glycol, 1,2-propylene glycol, 1,3-butanediol, 1,4-butanediol, neopentyl glycol, diethylene glycol, 3-methyl-1,5-pentanediol, 1,6-hexanediol, or trimethylol propane, or an alcohol-based solvent, such as methanol, ethanol, isopropylalcohol (“IPA”), or butanol, but is not limited thereto, and any known solvent that may dissolve the Pd precursor, Cu precursor, and transition metal (M) precursor may be used.

A pressure in the autoclave reactor may be about 300 pounds per square inch (psi) or less, for example, from about 100 psi to about 250 psi, specifically about 125 psi to about 225 psi. A microwave may be used as a heat source for the reduction reaction, and any suitable external heat source that may increase a temperature of the autoclave reactor may be used as well.

An output power of the microwave may be from about 800 watts (W) to about 1700 W, specifically about 900 W to about 1600 W. When the output power is within the range above, uniform alloy particles may be formed during the reduction of the Pd precursor, Cu precursor, and transition metal (M) precursor. Also a time for irradiating the microwaves may vary depending on conditions, such as a microwave output power and the like, and for example, the time may be from about 10 minutes to about 1 hour, particularly, from about 10 minutes to about 30 minutes.

When the microwave is used as the heat source of the reduction reaction, preparation and installation may be simplified and reaction time may be reduced.

The carbonaceous support may be further added to the metal precursor mixture.

In the autoclave reactor, a pH of the metal precursor mixture may be selected to be from about 10 to about 12, for example, about 11. The reduction reaction of the metal precursor mixture may be actively performed within the foregoing pH range.

A content of the solvent for the metal precursor mixture may be from about 100 parts to about 2000 parts by weight, specifically about 200 parts to about 1500 parts by weight, based on 100 parts by weight of the total weight of the Pd precursor, Cu precursor, and transition metal (M) precursor. When the content of the solvent is within the range above, uniform particles may be formed during the reduction of the precursors included in the mixture for forming a catalyst, and when the mixture for forming a catalyst further includes the carbonaceous support, a dispersibility of pre-particles in the carbonaceous support may be improved.

The transition metal (M) precursor may include at least one selected from a vanadium (V) precursor, a chromium (Cr) precursor, an iron (Fe) precursor, a manganese (Mn) precursor, a cobalt (Co) precursor, a nickel (Ni) precursor, and a zinc (Zn) precursor.

The Pd precursor, Cu precursor, and the transition metal (M) precursor may be a salt, and may be at least one selected from a chloride, nitrate, sulfate, acetate, acetylacetonate, cyanate, isopropyloxide, and a butoxide of Pd, Cu, and the transition metal (M), respectively.

The metal precursor mixture for obtaining the pre-catalyst may further include a chelating agent (e.g., ethylene diamine tetraacetic acid (“EDTA”), or an aqueous sodium citrate solution), a pH adjusting agent (e.g., an aqueous NaOH solution), and the like.

The reducing of the precursors in the metal precursor mixture may be performed by adding a reducing agent to the metal precursor mixture.

The reducing agent may be selected from materials that may reduce the precursors included in the mixture for forming a catalyst. For example, the reducing agent may comprise hydrazine, sodium borohydride (NaBH₄), or formic acid, but is not limited thereto. A content of the reducing agent may be from about 1 mole to about 3 moles, based on 1 mole of the Pd precursor, Cu precursor, and transition metal (M) as a whole. When the content of the reducing agent is within the range above, a satisfactory reduction reaction may be induced.

The electrode catalyst may be applied to transportable or a residential fuel cell, including a fuel cell for a portable device such as a laptop, cell phone, car, bus, or the like.

For example, when an electrode catalyst layer is formed using the electrode catalyst, an improved polymer electrolyte membrane fuel cell (“PEMFC”), phosphoric acid fuel cell (“PAFC”), or direct methanol fuel cell (“DMFC”) may be manufactured.

According to another aspect, provided is an electrode for a fuel cell including the electrode catalyst.

Hereinafter, a fuel cell including the electrode catalyst will be further described.

The fuel cell includes a cathode, an anode, and an electrolyte layer interposed between the cathode and the anode. Here, at least one of the cathode and the anode includes the electrode catalyst.

For example, the cathode may include the electrode catalyst according to an embodiment.

The fuel cell may maintain excellent activity of the electrode catalyst even when used for a long period of time and operated at a high temperature when using the catalyst as described above.

The fuel cell, for example, may be provided as a polymer electrolyte membrane fuel cell (“PEMFC”) or a direct methanol fuel cell (“DMFC”).

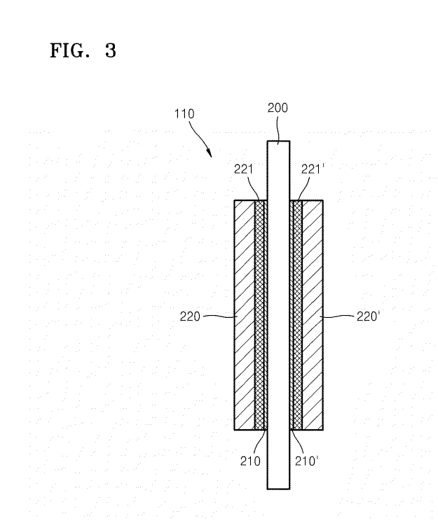

FIG. 2 is an exploded perspective view illustrating an embodiment of a fuel cell 100 and FIG. 3 is a schematic cross-sectional view illustrating a membrane electrode assembly (MEA) 110 of the fuel cell 100 of FIG. 2.

The fuel cell 100 schematically shown in FIG. 2 is comprises two unit cells 111 fastened between a pair of first and second holders 112 and 112′. The unit cell 111 comprises the MEA 110 and first and second bipolar plates 120 and 120′ disposed at opposite sides of the MEA 110 in a thickness direction. The bipolar plates 120 and 120′ may comprise a conductive metal or carbon and function as a current collector by respectively contacting the MEA 110 and at the same time, supply oxygen and fuel to a catalyst layer of the MEA 110.

In the fuel cell 100 shown in FIG. 2, the number of unit cells 111 is two, but the number of unit cells is not limited to two and may be increased to about a few tens to about a few hundred, e.g., about 2 to about 1000, specifically about 4 to about 500, according to characteristics desired for an application.

As shown in FIG. 3, the MEA 110 may comprise an electrolyte membrane 200, first and second catalyst layers 210 and 210′ disposed at opposite sides of the electrolyte membrane 200 in a thickness direction, in which the electrode catalyst according to the embodiment is applied to at least one of the catalyst layers 210 and 210′, first and second primary gas diffusion layers 221 and 221′ disposed, e.g., stacked on, the catalyst layers 210 and 210′, respectively, and first and second secondary gas diffusion layers 220 and 220′ disposed, e.g., stacked, on the primary gas diffusion layers 221 and 221′, respectively.

The catalyst layers 210 and 210′ may function as a fuel electrode and an oxygen electrode and may be formed by including a catalyst and a binder, respectively, therein. A material that may increase an electrochemical surface area of the catalyst may further be included. The catalyst layers 210 and 210′ may include the electrode catalyst according to an embodiment.

The primary gas diffusion layers 221 and 221′ and the secondary gas diffusion layers 220 and 220′, for example, may comprise a carbon sheet or carbon paper, respectively, and may diffuse oxygen and fuel, which are supplied through the bipolar plates 120 and 120′, to an entire surface of the catalyst layers 210 and 210′.

The fuel cell 100, including the MEA 110, may operate in a temperature range of about 100° C. to about 300° C. As a fuel, for example, hydrogen is supplied to one side of the first catalyst layer 210 through the first bipolar plate 120, and as an oxidizer, for example, oxygen is supplied to the other side of the second catalyst layer 210′ through the second bipolar plate 120′. Hydrogen is oxidized at one side of the first catalyst layer 210 to generate a hydrogen ion (H⁺), and a hydrogen ion (H⁺) arrives at the other side of the second catalyst layer 210′ by being conducted through the electrolyte membrane 200. Then, electrical energy as well as water (H₂O) is generated by electrochemically reacting the hydrogen ion (H⁺) and oxygen at the other side of the second catalyst layer 210′.

The hydrogen, which is supplied as a fuel, may be hydrogen generated by reforming hydrocarbon or an alcohol, and the oxygen supplied as the oxidizer may be supplied in the form of air.

The present disclosure will be described in further detail with reference to the following examples. However, these examples are for illustrative purposes only and are not intended to limit the scope of the present disclosure.

### Example 1

### Preparation of Electrode Catalyst

A carbonaceous support mixture was prepared by ultrasonically dispersing 0.3 grams (g) of a carbonaceous support VC (Vulcan-black, 250 m²/g) in 150 g of an ethylene glycol mixture for 30 minutes.

8.1 g of a 4 wt % Pd precursor, Pd(NH₃)₄Cl₂.H₂O, 2.8 g of a 8 wt % Ni precursor, NiCl₂.6H₂O, and 0.67 g of a Cu precursor, CuCl₂.2H₂O, dissolved in ethylene glycol were mixed with 9.57 g of a 1 molar (M) NaOH aqueous solution to prepare a metal precursor mixture.

The carbonaceous support mixture and the metal precursor mixture were combined to prepare an electrode catalyst composition, and the mixture was stirred for about 30 minutes.

The electrode catalyst composition was placed in a Teflon-sealed autoclave reactor, and then a temperature of the autoclave reactor was increased to about 250° C. by irradiating with microwaves at a power of 1600 watts (W) for about 30 minutes to perform a reduction reaction. Here, a pressure in the reactor was about 250 psi.

When the reaction was completed, the reduced electrode catalyst composition was filtered and dried to obtain a pre-catalyst (PdNi_{0.16}Cu_{0.09}/C). A content of active particles PdNi_{0.16}Cu_{0.19} in the pre-catalyst was about 37 parts by weight, based on 100 parts by weight of a total weight of the pre-catalyst (a total weight of the active particles and the carbonaceous support).

Separately, 12.5 g of a 4 wt % K₂PdCl₄ aqueous solution and 15.4 g of H₂IrCl₆.6H₂O, which are dissolved in an aqueous solution, were mixed with 16.6 g of a 30 wt % sodium citrate aqueous solution to prepare a metal precursor mixture. 44.5 g of the metal precursor mixture, 0.474 g of the pre-catalyst (Pd—Ni_{0.16}—Cu_{0.09}/C), and 155.5 g of water were mixed for about 10 minutes, and then the mixture was stirred at a reaction temperature of 160° C. to perform a galvanic replacement reaction.

When the reaction was completed, a product was filtered, washed, and dried, and then heat-treated in a hydrogen atmosphere at 500° C. so as to obtain a supported catalyst (PdNi_{0.16}Cu_{0.09} core, Pd_{0.19}Ir_{0.19} shell, C support) having a core of Pd—Ni_{0.16}—Cu_{0.09}/C and a shell of Pd_{0.19}Ir_{0.19}.

### Example 2

### Preparation of Electrode Catalyst

A supported catalyst (PdNi_{0.12}Cu_{0.14} core, Pd_{0.19}Ir_{0.19} shell, C support) having a core of PdNi_{0.12}Cu_{0.14}P/C and a shell of Pd_{0.19}Ir_{0.19} was obtained in the same manner as the preparation method of Example 1, except that a content of the Ni precursor, NiCl₂.6H₂O, was 1.83 g and a content of the Cu precursor, CuCl₂.2H₂O, was 1.31 g in the preparation of the metal precursor mixture.

### Comparative Example 1

### Preparation of Electrode Catalyst

A carbonaceous support mixture was prepared by ultrasonically dispersing 0.3 g of a carbonaceous support VC (Vulcan-black, 250 m²/g) in 150 g of a mixture of H₂O and isopropyl alcohol (IPA) (a weight ratio between H₂O and IPA was 67:33) for 30 minutes.

Here, a metal mixture including 12.264 g of a 4 wt % K₂PdCl₄ aqueous solution (a content of Pd in K₂PdCl₄ was 32.1 wt %), 7.554 g of a 4 wt % H₂IrCl₆.6H₂O aqueous solution (a content of Ir in H₂IrCl₆.6H₂O was 47.2 wt %), 1.859 g of a 4 wt % NiCl₂.6H₂O aqueous solution, and CuCl₂.2H₂O (at an atomic ratio of Ni and Cu of 3:1) was prepared so as to obtain a metal precursor mixture by mixing the metal mixture and 11.1 g of a 30 wt % sodium citrate aqueous solution as a chelating agent in a three-necked flask.

The metal precursor mixture was mixed with the carbonaceous support mixture to prepare a mixture for preparing a catalyst, and a pH of the mixture for preparing the catalyst was then adjusted to a range of about 10 to about 12 using a 1 M aqueous NaOH solution, and then the mixture was stirred for about 30 minutes.

The mixture for preparing the catalyst was transferred to an autoclave reactor, and catalyst particles on the carbonaceous support were reduced by increasing a reaction temperature to about 160° C. and holding the temperature for about 1 hour. An obtained product was filtered, washed, and dried.

The product was put in an alumina crucible and heat treated at about 500° C. for about 2 hours in a hydrogen (H₂) atmosphere, and then the heat treated product was cooled to room temperature (about 25° C.) to obtain an electrode catalyst (Pd—Ir_{0.14}—Ni_{0.1}—Cu_{0.05}/C).

### Comparative Example 2

### Preparation of Electrode Catalyst

An electrode catalyst (PdIr_{0.14}Ni_{0.1}Cu_{0.09}/C) was obtained in the same manner as the preparation method of Comparative Example 1, except that a content of the Ni precursor, NiCl₂.6H₂O, was 1.215 g and a content of the Cu precursor, CuCl₂.2H₂O, was 0.871 g.

### Evaluation Example 1

### Transmission Electron Microscope (TEM) Analysis

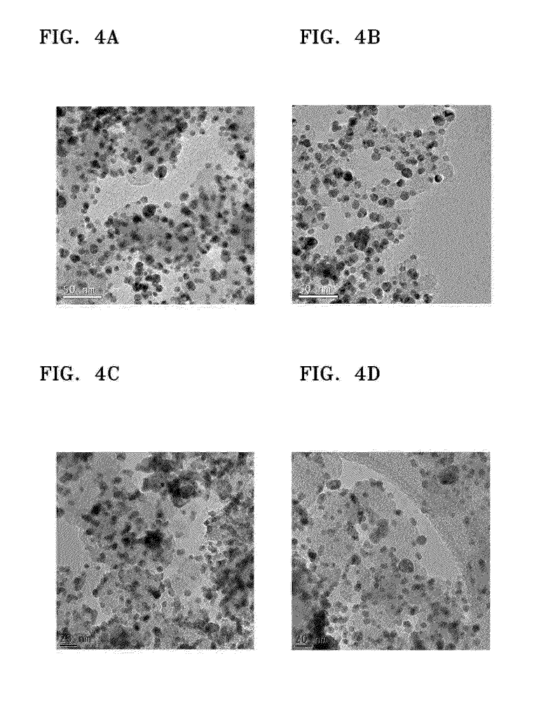

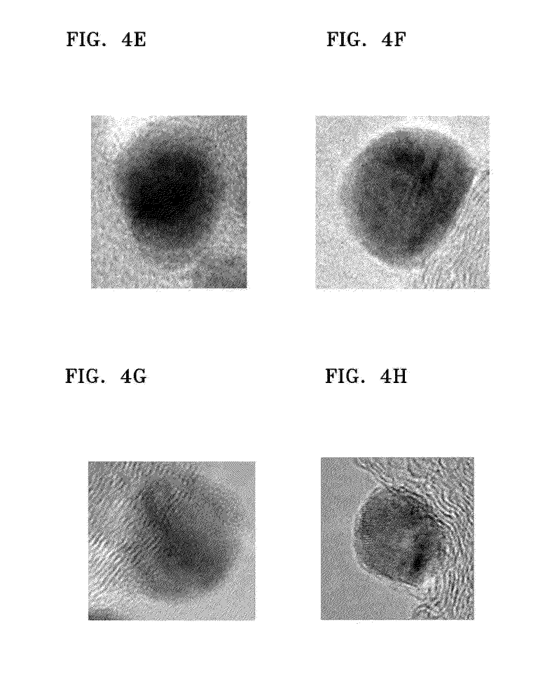

The electrode catalysts prepared in Examples 1-2 and Comparative Examples 1-2 were analyzed using a high-resolution transmission electron microscope (HR-TEM), and results thereof are shown in FIGS. 4A to 4H. FIGS. 4E to 4H are enlarged views of portions of FIGS. 4A to 4D, respectively

Referring to FIGS. 4A to 4H, it may be confirmed that the electrode catalysts of Examples 1-2 are evenly dispersed in the carbonaceous support. Also, as the electrode catalysts of Examples 1-2 showed different shade structures outside and inside the electrode catalysts of Examples 1-2, it may be confirmed that the structures of the electrode catalysts of Examples 1-2 have an Ir shell on the outside. Also, it was confirmed that the electrode catalysts of Comparative Examples 1-2 do not have a core-shell structure.

### Evaluation Example 2

### X-Ray Diffraction (“XRD”) Analysis

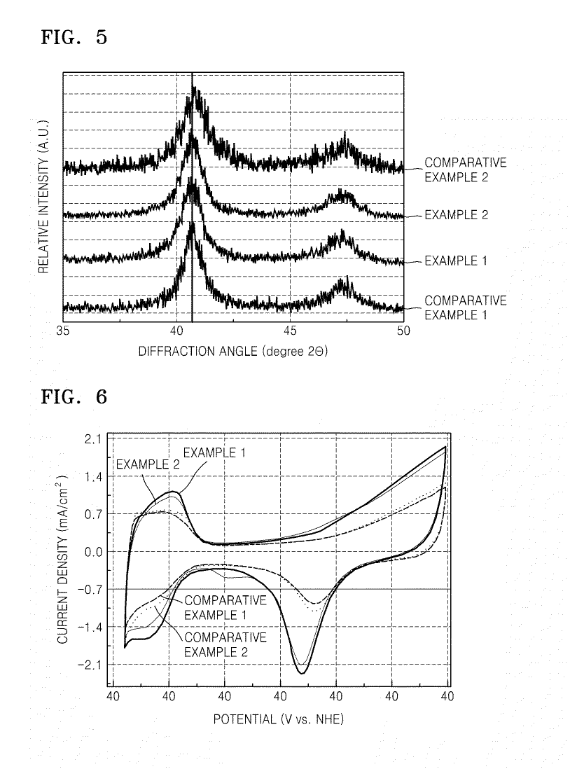

X-ray diffraction analyses (MP-XRD, X-pert PRO, Philips/power 3 kW) were performed on the catalysts of Examples 1-2 and Comparative Examples 1-2, and results thereof are shown in FIG. 5 and the following Table 1.

TABLE 1

| | Average particle diameter | Diffraction angle (2 theta) |
|---|---|---|
| | (nm) | of (111) peak in the XRD |
| Example 1 | 6.399 | 40.5012 |
| Example 2 | 6.298 | 40.5123 |
| Comparative | 7.117 | 40.6887 |
| Example 1 | | |
| Comparative | 7.146 | 40.6842 |
| Example 2 | | |

As shown in Table 1 and FIG. 5, formation of a Pd—Cu—Ni alloy was confirmed by the diffraction angle of the (111) peaks of the electrode catalysts of Examples 1-2, and an average particle diameter of catalyst active particles was obtained

Referring to Table 1 and FIG. 5, as the diffraction angles of the electrode catalysts of Examples 1-2 and Comparative Examples 1-2 are all shifted to the right compared to a diffraction angle of the (111) peak of palladium, 39.9°, it may be confirmed that the electrode catalysts of Examples 1-2 and Comparative Examples 1-2 have an alloy structure of Ni, Cu and Pd.

As shown in Table 1 and FIG. 5, the diffraction angle shift of the (111) peaks of the electrode catalysts of Examples 1-2 were smaller than the shift of the electrode catalysts of Comparative Examples 1-2. The results indicate that galvanic replacement of Ni and Cu in the cores of the electrode catalysts of Examples 1-2 to Pd and Ir occurred, and thus it may be confirmed that the electrode catalysts of Examples 1-2 have a core-shell structure. Also, referring to Table 1, it may be confirmed that average active particle diameters of the electrode catalysts of Examples 1-2 were smaller than average active particle diameters of the electrode catalysts of Comparative Examples 1-2. In this regard, when an average active particle diameter is reduced, electrochemical activity of an electrode catalyst is significantly increased.

### Evaluation Example 3

### Inductively Coupled Plasma (“ICP”) Analysis

ICP analyses (ICP-AES, ICPS-8100, SHIMADZU/RF source of about 27.12 MHz/sample uptake rate of about 0.8 milliliters per minute, mL/min) were performed on the catalyst prepared in the same manner as in Examples 1-2 and Comparative Examples 1-2, and results thereof are shown in Table 2.

TABLE 2

ICP analysis results (wt %)

| | Pd | Ir | Ni | Cu |
|---|---|---|---|---|
| Example 1 | 42.3 | 12.1 | 2.95 | 1.75 |
| Example 2 | 40.2 | 11.6 | 2.25 | 2.91 |
| Comparative | 40.8 | 10.5 | 2.66 | 1.12 |
| Example 1 | | | | |
| Comparative | 40.8 | 10.1 | 2.2 | 2.28 |
| Example 2 | | | | |

As shown in Table 2, presence and elemental content of the catalysts of Examples 1-2 and Comparative Examples 1-2 were confirmed.

Referring to Table 2, a total content of Cu and Ni may be 4.7 wt % and 5.16 wt % (approximately from about 4.5 wt % to about 5 wt %), respectively, and a content of Ir in the shell, may be about 12 wt %. Since contents of Pd and Ir to form the shell were added at an atomic ratio of 2:1, a content of Pd may be calculated from the content of Ir, and thus the content of Pd was about 13 wt %. In this regard, a content of a Pd—Ir alloy of the shell may be confirmed to be about 25 wt %, and a content of Pd present in the core may be confirmed by calculating the content of Pd, that is about 28 wt %, present in the shell. With the calculation, a weight ratio of the core and shell may be confirmed as being about 1:1.

### Evaluation Example 4

### Cyclic Voltammogram and Hydrogen Desorption Charge Evaluation

Electrodes were prepared respectively including the catalysts obtained in Examples 1-2 and Comparative Examples 1-2, and cyclic voltammograms and hydrogen desorption charges thereof were evaluated.

To prepare the electrodes, about 0.02 g of the catalyst was dispersed in about 10 g of ethylene glycol to obtain an ethylene glycol dispersed solution of a catalyst. About 15 microliters (μL) of the dispersed solution was dripped onto a glassy carbon rotating electrode using a micropipette, and vacuum drying was performed at about 80° C. Then, about 15 μL of about 5 wt % of a Nafion in ethylene glycol solution was dripped onto the electrode, in which the catalyst had been dispensed, and a working electrode was prepared by vacuum drying the electrode at about 80° C.

The working electrode thus prepared was installed in a rotating disk electrode (“RDE”) apparatus, and a platinum wire and a saturated calomel electrode (Ag/AgCl (KClₛₐₜ)) were prepared as a counter electrode and a reference electrode, respectively. The prepared three-phase electrode was put in a 0.1 M HClO₄ electrolyte solution and residual oxygen in the solution was removed by performing nitrogen bubbling for about 30 minutes. Current density values were measured by performing cyclic voltammetry in a range of about 0.03 V to about 1.2 V (vs. normal hydrogen electrode (NHE)) using a potentiostat/galvanostat, and results are shown in FIG. 6.

A hydrogen desorption charge (Q_{H}) per active particle surface area for each catalyst was determined from an area obtained by multiplying a current density value and a voltage value within a range of about 0 V to about 0.4 V (vs. NHE) in a cyclic voltammogram of each catalyst, and results thereof are presented in the following Table 3. The hydrogen desorption charge is an amount of hydrogen ions adsorbed with respect to catalyst particles in a catalyst and is a basis for calculating an electrochemical specific surface area of each catalyst.

TABLE 3

| | Q_{H} (mC/cm²)¹ |
|---|---|
| Example 1 | 32.1 × 10⁻³ |
| Example 2 | 31 × 10⁻³ |
| Comparative Example 1 | 20 × 10⁻³ |
| Comparative Example 2 | 18 × 10⁻³ |

¹a hydrogen desorption charge per active particle surface area (cm²) of each catalyst, mC/cm² refers to millicoulombs per square centimeter.

As shown in Table 3 and FIG. 6, it is apparent that hydrogen desorption charges of the catalysts of Examples 1-2 were higher than those of the catalysts of Comparative Examples 1-2.

### Evaluation Example 5

### Oxygen Reduction Reaction Characteristics Evaluation

About 0.02 g of each catalyst was dispersed in about 10 g of ethylene glycol to obtain an ethylene glycol dispersed solution of the catalyst. About 15 μL of the dispersed solution was dripped onto a glassy carbon rotating electrode using a micropipette, and vacuum drying was performed at about 80° C. Then, about 15 μL of about 5 wt % of a Nafion in ethylene glycol solution was dripped onto the electrode, in which the catalyst had been dispensed, and a working electrode was prepared by vacuum drying the electrode at about 80° C.

The working electrode thus prepared was installed in a rotating disk electrode (“RDE”) apparatus, and a platinum wire and a saturated calomel electrode (Ag/AgCl (KClₛₐₜ)) were prepared as a counter electrode and a reference electrode, respectively. The prepared three-phase electrode was put in a 0.1 M HClO₄ electrolyte solution and residual oxygen in the solution was removed by performing nitrogen bubbling for about 30 minutes. Current density values were measured by performing cyclic voltammetry in a range of about 0.03 V to about 1.2 V (vs. normal hydrogen electrode (“NHE”)) using a potentiostat/galvanostat.

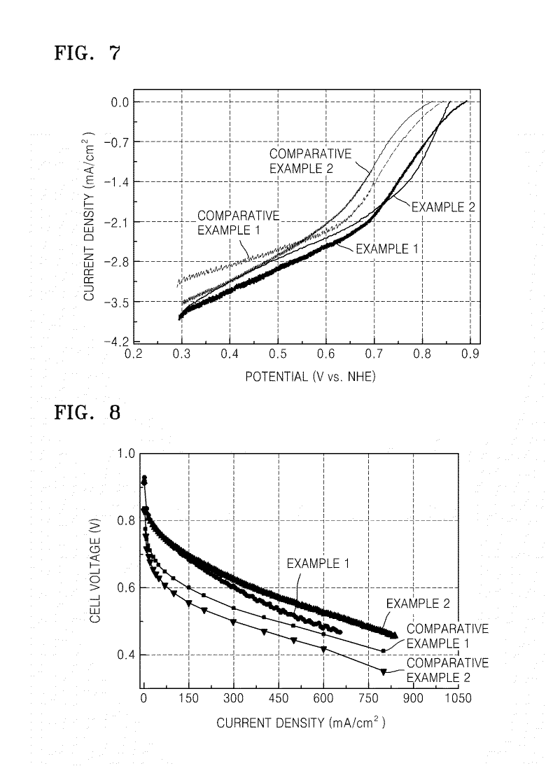

Next, oxygen was dissolved and saturated in the electrolyte solution, and oxygen reduction reaction (“ORR”) current densities were then recorded in a negative direction from open circuit voltage (“OCV”) to a potential (about 0.3 V to about 0.9 V vs. NHE) for generating a mass transfer limiting current while the glassy carbon rotating electrode was rotated. The current densities are shown in FIG. 7. Current densities at a potential of about 0.8 V are shown in Table 4 and FIG. 7.

TABLE 4

| | Current density (mA/cm²) |
|---|---|
| Example 1 | −1.07 |
| Example 2 | −0.76 |
| Comparative Example 1 | −0.29 |
| Comparative Example 2 | −0.11 |

As shown in FIG. 7 and Table 4, it may be confirmed that the ORR reactivities of the catalysts prepared in Examples 1-2 were better than that of the catalyst of Comparative Examples 1-2.

### Evaluation Example 6

### Performance Evaluation of Unit Cell

### 1) Preparation of Unit Cell

Unit cells were prepared as follows using the catalysts prepared in Examples 1-2 and Comparative Examples 1-2.

A slurry for a cathode was prepared by mixing 0.03 g of polyvinylidene fluoride (“PVDF”) for every 1 g of each of the catalysts with an appropriate amount of the solvent N-methyl pyrrolidone (“NMP”). A carbon paper coated with a microporous layer was coated with the slurry using a bar coater and a cathode was then prepared through a drying process in which a temperature was increased stepwise from room temperature to about 150° C. A loading amount of each of the catalysts in the cathode was about 2.5 mg/cm².

An anode was prepared by using a PtRu/C catalyst and a loading amount of the PtRu/C catalyst in the anode was about 0.8 mg/cm².

An electrolyte membrane was prepared as follows.

50 parts by weight of a poly(p-phenylene oxide) (“PPO”) represented by Formula 1 below and 50 parts by weight of polybenzimidazole (m-“PBI”) represented by Formula 2 were blended, and a curing reaction was performed on the blend at a temperature in a range from about 80° C. to about 220° C.

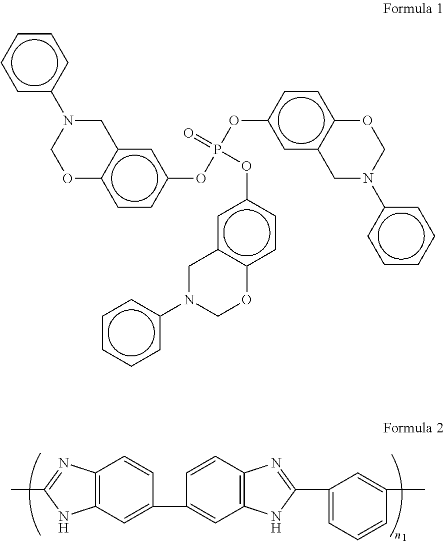

In Formula 2, n₁ is 130. Each of electrolyte membranes was prepared by being doped with about 85 wt % of phosphoric acid for about 4 hours or more. Here, a content of the phosphoric acid was about 500 parts by weight based on 100 parts by weight of a total weight of each of the electrolyte membranes.

A membrane electrode assembly (“MEA”) was prepared by interposing each of the electrolyte membranes between the cathode and the anode.

### 2) Unit Cell Test

Performance of the MEA was evaluated at a temperature of about 150° C. using non-humidified air (250 cubic centimeters per minute, cc/min) for the cathode and non-humidified hydrogen (100 cc/min) for the anode, and results thereof are shown in FIG. 8 and Table 5.

TABLE 5

| | Potential (V) @ 0.2 A/cm² |
|---|---|
| Example 1 | 0.65 |
| Example 2 | 0.67 |
| Comparative Example 1 | 0.577 |
| Comparative Example 2 | 0.536 |

As shown in Table 5, the unit cell having one of the catalysts of Examples 1-2 had improved potential characteristics compared to the unit cells of Comparative Examples 1-2.

As described above, according to the one or more of the above embodiments, an electrode catalyst for a fuel cell has excellent specific surface area, stability, and oxygen reduction reaction activity. When the electrode catalyst is used, a fuel cell having improved cell performance may be manufactured.

It should be understood that the exemplary embodiments described herein should be considered in a descriptive sense only and not for purposes of limitation. Descriptions of features, advantages, or aspects within each embodiment should be considered as available for other similar features, advantages or aspects in other embodiments.

What is claimed is:

1. An electrode catalyst for a fuel cell, wherein the electrode catalyst comprises an active particle comprising:
a core comprising an alloy represented by Formula 1
PdCuₐM_{b} Formula 1
wherein M is a transition metal, 0.05≦a≦0.32, and 0<b≦0.2; and
a shell comprising a Pd alloy on the core.

2. The electrode catalyst of claim 1, wherein the Pd alloy of the shell is a palladium-iridium alloy represented by Formula 2:
Pd_{c}Ir_{d} Formula 2
wherein 0.15≦c≦0.38, and 0.075≦d≦0.22, and wherein c and d are each based on 1 mole of the Pd of the core.

3. The electrode catalyst of claim 1, wherein in Formula 1 b is 0.03≦b≦0.2.

4. The electrode catalyst of claim 1, wherein M in Formula 1 M is at least one selected from vanadium, chromium, iron, manganese, cobalt, nickel, copper, and zinc.

5. The electrode catalyst of claim 1, wherein an average particle diameter of a plurality of the active particles is from about 1 nanometer to about 20 nanometers.

6. The electrode catalyst of claim 1, wherein a weight ratio of the core to the shell is from about 1:1 to about 1.5:1.

7. The electrode catalyst of claim 1, wherein the electrode catalyst further comprises a carbonaceous support disposed on the active particle.

8. The electrode catalyst of claim 7, wherein a content of the active particle is from about 20 parts to about 80 parts by weight, based on 100 parts by weight of the carbonaceous support and the active particle.

9. The electrode catalyst of claim 1, wherein the alloy represented by Formula 1 is PdNi_{0.16}Cu_{0.09} or PdNi_{0.12}Cu_{0.14}.

10. The electrode catalyst of claim 1, wherein the Pd alloy is Pd_{0.19}Ir_{0.19}.

11. An electrode for a fuel cell, wherein the electrode comprises an electrode catalyst comprising an active particle comprising:
a core comprising an alloy represented by Formula 1
PdCuₐM_{b} Formula 1
wherein M is a transition metal, 0.05≦a≦0.32, and 0<b≦0.2; and
a shell comprising a Pd alloy on the core.

12. The electrode for a fuel cell catalyst of claim 11, wherein the Pd alloy of the shell is a palladium-iridium alloy represented by Formula 2:
Pd_{c}Ir_{d} Formula 2
wherein 0.15≦c≦0.38, and 0.075≦d≦0.22, and wherein c and d are each based on 1 mole of the Pd of the core.

13. The electrode for a fuel cell catalyst of claim 11, wherein M in Formula 1 M is at least one selected from vanadium, chromium, iron, manganese, cobalt, nickel, copper, and zinc.

14. The electrode for a fuel cell catalyst of claim 11, wherein an average particle diameter of a plurality of the active particles is from about 1 nanometer to about 20 nanometers.

15. The electrode for a fuel cell catalyst of claim 11, wherein a weight ratio of the core to the shell is from about 1:1 to about 1.5:1.

16. The electrode for a fuel cell catalyst of claim 11, wherein the electrode catalyst further comprises a carbonaceous support disposed on the active particle.

17. The electrode for a fuel cell catalyst of claim 11, wherein a content of the active particle is from about 20 parts to about 80 parts by weight, based on a total weight of the electrode catalyst.

18. The electrode for a fuel cell catalyst of claim 11, wherein the alloy represented by Formula 1 is PdNi_{0.16}Cu_{0.09} or PdNi_{0.12}Cu_{0.14}.

19. The electrode of claim 11, wherein the electrode is a cathode.

20. A fuel cell comprising:
a cathode;
an anode disposed facing the cathode; and
an electrolyte membrane interposed between the cathode and the anode,
wherein at least one of the cathode and the anode comprises the electrode catalyst of claim 1.
